(19) United States
(12) Patent Application Publication
(10) Pub. No.: US 2015/0284590 A1
(43) Pub. Date: Oct. 8, 2015

(54) CURABLE ORGANOPOLYSILOXANE COMPOSITION, SHEET-LIKE ARTICLE HAVING A CURED LAYER FORMED FROM SAID COMPOSITION, AND LAMINATE

(71) Applicant: DOW CORNING TORAY CO., LTD., Tokyo (JP)

(72) Inventors: Syuji Endo, Chiba (JP); Toshikazu Tani, Ichikawa (JP); Takateru Yamada, Ichihara (JP)

(21) Appl. No.: 14/433,745

(22) PCT Filed: Oct. 9, 2013
(86) PCT No.: PCT/JP2013/078114

§ 371 Date: Apr. 6, 2015

(30) Foreign Application Priority Data
Oct. 9, 2012 (JP) 2012-224506

(51) Int. Cl. C09D 183/04; B32B 7/06; C08G 77/04; B32B 7/12

(52) U.S. Cl. CPC C09D 183/04; B32B 7/12; B32B 7/06; C08G 77/04; B32B 2255/26

(57) ABSTRACT

A curable organopolysiloxane composition comprising: (A) at least one type of gum-like or liquid organopolysiloxane having a viscosity of not less than 20 mPa·s, a content of the vinyl(CH₂═CH—) part of higher alkenyl groups being in a range of 2.0 to 5.0% by mass; (B) an organopolysiloxane resin formed essentially from R¹₃SiO_{1/2} units and SiO_{4/2} units, a molar ratio of the R¹₃SiO_{1/2} units to the SiO_{4/2} units being from 0.5 to 2.0 and a content of the vinyl(CH₂═CH—) part of alkenyl groups being less than 1.0% by mass; (C) an organohydrogenpolysiloxane; (D) a hydrosilylation reaction catalyst; and, optionally, (E) an organic solvent. In such a composition, a mass ratio of the component (A) to the component (B) is in a range of 2/8 to 8/2.

### TECHNICAL FIELD

The present invention relates to a curable organopolysiloxane composition that can be used to form a cured layer that has heavy releasability, and which displays little change in releasing force over time. More specifically, the present invention relates to a curable organopolysiloxane composition that is easy to handle, can be formed into a cured layer on a surface of a substrate, and can impart excellent heavy releasability with respect to adhesive materials. Moreover the present invention relates to a sheet-like substrate having a cured layer formed by curing the curable organopolysiloxane composition and particularly relates to a laminate comprising the sheet-like substrate and a surface protection sheet. Priorities are claimed on Japanese Patent Application No. 2012-224506 filed on Oct. 9, 2012, the content of which are incorporated herein by reference.

### BACKGROUND ART

Methods for imparting releasability with respect to adhesive materials by forming a cured layer of an organopolysiloxane composition on a surface of a substrate such as various types of paper, laminated paper, synthetic film, metal foil or the like are well known in the art. In the method for forming a releasable cured layer, an addition reaction-type organopolysiloxane composition obtained by addition reacting an organopolysiloxane having an unsaturated hydrocarbon group and an organohydrogenpolysiloxane in the presence of a hydrosilylation reaction catalyst is widely used. However, the releasing force of silicone-based release coating layers is often extremely low. Therefore, adding a heavy release additive (release adjusting agent) in order to increase the releasing force of the silicone-based release agent in applications where necessary is known. Particularly, use of silicone resin as a heavy release additive that consists of a monovalent siloxane group (M) (wherein R is a R³SiO_{1/2} group that is a hydroxyl group or a monovalent hydrocarbon group) and a tetravalent siloxane group (SiO_{4/2} group) is known (see, for example, Patent Documents 1 and 2). However, while improvements in initial heavy release characteristics can be expected as a result of adding such silicone resins, there is a problem in that the release characteristics are prone to change over time and, particularly, there is a problem in that the releasing force decreases greatly over time when aged over an extended period of time at high temperatures.

On the other hand, Patent Document 3 proposes a release agent composition including 100 parts by mass of an organopolysiloxane having an aryl group on the side chain in addition to alkenyl groups and from 1 to 50 parts by mass of silicone resin for the purpose of improving the stability over time of the releasing force. However, a release sheet obtained using such a release agent composition has a releasing force that is less than 2000 mN/50 mm and, thus, there has been a problem in that these compositions cannot provide heavy releasable silicone release layers such as those having a releasing force that exceeds 5000 mN/50 mm. Additionally, the release sheet recited in Practical Example 3 of Patent Document 3 has a releasing force of 260 mN/50 mm, which is a release sheet having extremely light releasability. While there was no change in releasing force during one month with this release sheet, in the other Practical Examples, the change in releasing force exceeded 15%. Thus, there is still room for improvement in terms of suppressing the change over time in releasing force.

On the other hand, organopolysiloxanes having higher alkenyl groups such as hexenyl groups and the like are known to be usable as base compounds of organopolysiloxane compositions that are curable via addition reactions, and are also known to be able to improve curing properties at low temperatures, release characteristics with respect to adhesive materials, and the like (see Patent Documents 4 to 8).

However, in these documents, there is no recitation about the use of a silicone resin or improving the heavy release characteristics and there has been a problem in that these compositions cannot provide heavy releasable silicone release layers such as those having a releasing force that exceeds 5000 mN/50 mm. Furthermore, if a heavy release additive is simply added to a release agent in which these higher alkenyl group-containing organopolysiloxanes are used, it is not possible to suppress the change over time in the releasing force and, particularly, there is a problem in that releasing force decreases greatly over time when aged over an extended period of time at high temperatures.

### PRIOR ART DOCUMENTS

### Patent Documents

Patent Document 1: Japanese Examined Patent Application Publication No. S49-027033

Patent Document 2: Japanese Unexamined Patent Application Publication No. H10-195387A

Patent Document 3: Japanese Unexamined Patent Application Publication No. 2009-203281A

Patent Document 4: Japanese Unexamined Patent Application Publication No. H02-145650A

Patent Document 5: Japanese Unexamined Patent Application Publication No. H04-020570A

Patent Document 6: Japanese Unexamined Patent Application Publication No. H05-171047A

Patent Document 7: Japanese Unexamined Patent Application Publication No. H06-049413A

Patent Document 8: Japanese Unexamined Patent Application Publication (Translation of PCT Application) No. H09-507523A

### SUMMARY OF INVENTION

### Technical Problem

In order to solve the problems described above, an object of the present invention is to provide a curable organopolysiloxane composition that forms a cured layer having superior high releasability with respect to adhesive materials (heavy releasability), and which displays little change in releasing force over time.

Another object of the present invention is to provide a sheet-like article having a cured layer formed by curing the curable organopolysiloxane composition and particularly to provide a laminate comprising said sheet-like article and a surface protection sheet.

### Solution to Problem

The objects described above are achieved by a curable organopolysiloxane composition comprising:

(A) at least one type of gum-like or liquid organopolysiloxane having a viscosity at 25° C. of not less than 20 mPa·s, a content of the vinyl(CH₂═CH—) part of higher alkenyl groups having from 4 to 12 carbons being in a range of 2.0 to 5.0% by mass; (B) an organopolysiloxane resin essentially comprising R¹₃SiO_{1/2} units (wherein R¹ are each individually hydroxyl groups, alkoxy groups having from 1 to 6 carbons, or substituted or unsubstituted monovalent hydrocarbon groups having from 1 to 10 carbons) and SiO_{4/2} units, a molar ratio of the R¹₃SiO_{1/2} units to the SiO_{4/2} units being from 0.5 to 2.0 and a content of the vinyl(CH₂═CH—) part of the alkenyl groups being less than 1.0% by mass; (C) an organohydrogenpolysiloxane having two or more silicon-bonded hydrogen atoms (Si—H) in each molecule; and (D) a hydrosilylation reaction catalyst. In such a composition, a mass ratio of the component (A) to the component (B) is in a range of 2/8 to 8/2.

Specifically, the objects of the present invention are achieved by:

[1] A curable organopolysiloxane composition comprising:
(A) at least one type of gum-like or liquid organopolysiloxane having a viscosity at 25° C. of not less than 20 mPa·s, a content of the vinyl(CH₂═CH—) part of higher alkenyl groups having from 4 to 12 carbons being in a range of 2.0 to 5.0% by mass;
(B) an organopolysiloxane resin essentially comprising R¹₃SiO_{1/2} units (wherein R¹ are each individually hydroxyl groups, alkoxy groups having from 1 to 6 carbons, or substituted or unsubstituted monovalent hydrocarbon groups having from 1 to 10 carbons) and SiO_{4/2} units, a molar ratio of the R¹₃SiO_{1/2} units to the SiO_{4/2} units being from 0.5 to 2.0 and a content of the vinyl(CH₂═CH—) part of the alkenyl groups being less than 1.0% by mass;
(C) an organohydrogenpolysiloxane having two or more silicon-bonded hydrogen atoms (Si—H) in each molecule;
(D) a hydrosilylation reaction catalyst;
a mass ratio of the component (A) to the component (B) being in a range of 2/8 to 8/2.
[2] The curable organopolysiloxane composition described in [1], wherein:
the component (B) is an organopolysiloxane resin consisting of R²₃SiO_{1/2} units (wherein R² are each individually alkyl groups having from 1 to 10 carbons or alkenyl groups having from 2 to 10 carbons) and SiO_{4/2} units;
the molar ratio of the R¹₃SiO_{1/2} units to the SiO_{4/2} units is from 0.5 to 1.0; and the content of the vinyl(CH₂═CH—) part of the alkenyl groups is less than 1.0% by mass.
[3] The curable organopolysiloxane composition described in [1] or [2], wherein:
the component (B) is an alkenyl group-free organopolysiloxane resin consisting of R³₃SiO_{1/2} units (wherein R³ are each individually alkyl groups having from 1 to 10 carbons) and SiO_{4/2} units; and
the molar ratio of the R¹₃SiO_{1/2} units to the SiO_{4/2} units is from 0.5 to 1.0.
[4] The curable organopolysiloxane composition described in any one of [1] to [3], wherein the component (A) is an organopolysiloxane wherein a content of the vinyl(CH₂═CH—) part of hexenyl groups is in a range of 2.5 to 3.5% by mass.
[5] The curable organopolysiloxane composition described in [1], wherein the mass ratio of the component (A) to the component (B) is in a range of 6/4 to 4/6.
[6] A sheet-like article having a cured layer formed by heat curing the curable organopolysiloxane composition described in any one of [1] to [5].
[7] The sheet-like article described in [6], wherein the cured layer is formed by applying the curable organopolysiloxane composition described in any one of [1] to [5] to a sheet-like substrate at an amount of 0.01 to 100.0 g/m², and then heat curing.
[8] The sheet-like article described in [6] or [7], wherein the substrate is a polyethylene laminated paper or a plastic film.
[9] A surface protection sheet comprising the sheet-like article described in any one of [6] to [8].
[10] A laminate formed by adhering:
(SA) an adhesive sheet having an adhesive agent layer on at least one side of a sheet-like substrate to
(S1) a sheet-like substrate having a cured layer, formed by heat curing the curable organopolysiloxane composition described in any one of [1] to [5], on at least one side thereof, so that the adhesive agent layer contacts the cured layer.
[11] A laminate formed by adhering:
(SR) a release sheet having a release layer on at least one side of a sheet-like substrate to
(S1) a sheet-like substrate having a cured layer, formed by heat curing the curable organopolysiloxane composition described in any one of [1] to [5], on at least one side thereof, so that the release layer contacts the cured layer.

### Advantageous Effects of Invention

According to the curable organopolysiloxane composition of the present invention, a curable organopolysiloxane composition that forms a cured layer that has high releasing force (heavy releasability) with respect to adhesive materials, and which displays little change in releasing force over time can be provided. Furthermore, a sheet-like article having the cured layer that displays the technical benefits described above and that is formed by curing the composition, and particularly a laminate comprising said sheet-like article and a surface protection sheet can be provided.

### DESCRIPTION OF EMBODIMENTS

The curable organopolysiloxane composition according to the present invention comprises: (A) at least one type of gum-like or liquid organopolysiloxane having a viscosity at 25° C. of not less than 20 mPa·s, a content of the vinyl(CH₂═CH—) part of higher alkenyl groups having from 4 to 12 carbons being in a range of 2.0 to 5.0% by mass; (B) an organopolysiloxane resin essentially comprising R¹₃SiO_{1/2} units (wherein R¹ are each individually hydroxyl groups, alkoxy groups having from 1 to 6 carbons, or substituted or unsubstituted monovalent hydrocarbon groups having from 1 to 10 carbons) and SiO_{4/2} units, a molar ratio of the R¹₃SiO_{1/2} units to the SiO_{4/2} units being from 0.5 to 1.0 and a content of the vinyl(CH₂═CH—) part of the alkenyl groups being less than 1.0% by mass; (C) an organohydrogenpolysiloxane having two or more silicon-bonded hydrogen atoms (Si—H) in each molecule, and (D) a hydrosilylation reaction catalyst. In such a composition, a mass ratio of the component (A) to the component (B) is in a range of 2/8 to 8/2. The constituents of the curable organopolysiloxane composition and the sheet-like article and laminate formed using the composition are described in detail hereinafter.

Component (A) is at least one type of gum-like or liquid organopolysiloxane having a viscosity at 25° C. of not less than 20 mPa·s, a content of the vinyl(CH₂═CH—) part of higher alkenyl groups having from 4 to 12 carbons being in a range of 2.0 to 5.0% by mass. The component (A) has low viscosity and a high content of higher alkenyl groups such as hexenyl groups or the like. By using the component (A) as the base compound, a cured layer having a high crosslinking density can be formed on the surface of a substrate. Moreover, by using the component (A) in combination with a non-reactive or low-reactive organopolysiloxane resin that has a content of the vinyl(CH₂═CH—) part of alkenyl groups of less than 1.0% by mass, bleeding out of the resin component to the surface of the layer is accelerated. Thus, a cured layer (silicone release layer) having superior heavy releasability and superior stability in releasing force over time is formed. If the content of the vinyl(CH₂═CH—) part of the higher alkenyl groups is less than the lower limit described above, releasing force will decline greatly over time and, as a result, the object of the present invention will not be achievable. Moreover, if the content of the vinyl(CH₂═CH—) part of the higher alkenyl groups exceeds the upper limit described above, the bleeding out of component (B) to the surface of the cured layer will be inhibited and the technical benefits, namely the imparting of heavy releasability, may be obstructed.

The viscosity at 25° C. of the component (A) is not less than 20 mPa·s. However, if the viscosity is set to less than this value, it may be difficult to obtain the preferable range for the content of the higher alkenyl groups having from 4 to 12 carbons (described hereinafter). On the other hand, provided that the viscosity is 20 mPa·s or greater, the component (A) may be in a gum-like or liquid state at 25° C. Herein the “gum-like” means a semi-solid highly polymerized silicone polymer that has plasticity and normally a viscosity of greater than or equal to Ser. No. 10/000,000 mP·s, wherein the viscosity is unmeasurable with rotatory viscometer etc. From an industrial perspective, the viscosity at 25° C. is preferably in a range of 20 to 1,000 mPa·s and more preferably is in a range of 20 to 500 mPa·s. Moreover, the component (A) may be a mixture of two or more components having different viscosities. Furthermore, even when content (A) is a mixture of gum-like state organopolysiloxane and liquid organopolysiloxane, the preferred range of entire viscosity in the mixture is the same as described in above.

The component (A) is characterized by the content of the vinyl(CH₂═CH—) part of the higher alkenyl groups having from 4 to 12 carbons being in the range of 2.0 to 5.0% by mass. From the perspective of the technical benefits of the present invention, the content of the vinyl(CH₂═CH—) part of the higher alkenyl groups having from 4 to 12 carbons in the component

(A) is preferably in a range of 2.5 to 4.0% by mass. It is particularly preferable that the higher alkenyl groups having from 4 to 12 carbons are hexenyl groups. Note that from the perspective of the technical benefits of suppressing changes in dynamic coefficient of friction and speed dependency thereof depending on the thickness of the cured layer, the component (A) is preferably a mixture of two or more types of organopolysiloxanes and the content of the vinyl(CH₂═CH—) part of the higher alkenyl groups in the mixture is preferably in a range of 2.5 to 4.0% by mass.

The component (A) described above may be an organopolysiloxane having a straight, branched, or partially cyclic structure, but from an industrial perspective, the component (A) is preferably a straight organopolysiloxane represented by the following structural formula.

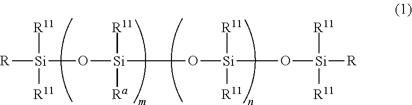

In structural formula (1), R¹¹ are each independently unsubstituted or halogen atom substituted alkyl groups having from 1 to 20 carbons (i.e. methyl groups or the like), aryl groups having from 6 to 22 carbons (i.e. phenyl groups or the like), lower alkenyl groups having from 2 to 3 carbons (i.e. vinyl groups or allyl groups), or hydroxyl groups. R^{a} is a higher alkenyl group having from 4 to 12 carbons. R is the group represented by R¹¹ or R^{a}. “m” is a number greater than or equal to 0 and “n” is a number greater than or equal to 1. However, m, n, and R are numbers such that the content of the vinyl(CH₂═CH—) part of the higher alkenyl groups having from 4 to 12 carbons in the organopolysiloxane represented by the structural formula above is within the range described above.

For example, when both terminal R are higher alkenyl groups having from 4 to 12 carbons (R^{a}), the content of the vinyl(CH₂═CH—) part of the higher alkenyl groups having from 4 to 12 carbons represented by:

{(molecular weight of CH₂═CH part)×(m+2)}/gross molecular weight×100(% by mass)

is in a range of 3.0 to 5.0% by mass, and more preferably is in a range of 2.5 to 4.0% by mass. Furthermore, m+n is a number in a range such that the viscosity at 25° C. of the organopolysiloxane represented by the structural formula above is not less than 20 mPa·s, particularly preferably in a range of 20 to 1,000 mPa·s.

The component (A) is particularly preferably an organopolysiloxane having hexenyl groups on the side chain and at both molecular terminals such as that represented by the structural formula below.

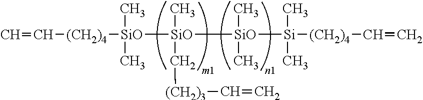

In this formula, “m1” and “n1” are each positive numbers. m1 is a number such that the content of the vinyl(CH₂═CH—) part of hexenyl groups (—(CH₂)₄CH═CH₂) in each molecule is in a range of 2.0 to 5.0% by mass, more preferably in a range of 2.5 to 4.0% by mass. Additionally, m1+n1 is a number in a range such that the viscosity at 25° C. is not less than 20 mPa·s and more preferably is a number such that the viscosity at 25° C. is in a range of 20 to 1,000 mPa·s.

Component (B) is a heavy release additive. More specifically, the component (B) is a component that functions to impart high releasing force to the surface of the cured layer with respect to adhesive materials as a result of effectively bleeding out onto a cured layer surface that is formed by curing and has a high crosslinking density due to the usage of the component (A).

The component (B) is an organopolysiloxane resin essentially comprising R¹₃SiO_{1/2} units (wherein R¹ are each individually hydroxyl groups, alkoxy groups having from 1 to 6 carbons, or substituted or unsubstituted monovalent hydrocarbon groups having from 1 to 10 carbons) and SiO_{4/2} units, a molar ratio of the R¹₃SiO_{1/2} units to the SiO_{4/2} units being from 0.5 to 2.0 and a content of the vinyl(CH₂═CH—) part of the alkenyl groups being less than 1.0% by mass.

In this formula, R¹ are each individually hydroxyl groups, alkoxy groups having from 1 to 6 carbons, or substituted or unsubstituted monovalent hydrocarbon groups having from 1 to 10 carbons. In this case, the hydroxyl groups are silicon-bonded hydroxyl groups, namely silanol groups (—OH). Examples of the alkoxy groups having from 1 to 6 carbons include methoxy groups, ethoxy groups, propoxy groups, and butoxy groups. The substituted or unsubstituted monovalent hydrocarbon groups having from 1 to 10 carbons are not particularly limited and examples thereof include methyl groups, ethyl groups, propyl groups, butyl groups, hexyl groups, heptyl groups, octyl groups, nonyl groups, decyl groups, and similar alkyl groups; vinyl groups, allyl groups, butyl groups, hexenyl groups, and similar alkenyl groups; phenyl groups, tolyl groups, xylyl groups, and similar aryl groups; benzyl groups, phenethyl groups, and similar aralkyl groups; 3-chloropropyl groups, perfluoroalkyl groups (e.g. 3,3,3-trifluoropropyl groups, pentafluorobutyl groups), and similar halogenated alkyl groups; etherified perfluoroalkyl groups; and cyanoethyl groups. Of these, R¹ are preferably alkyl groups having from 1 to 10 carbons, halogenated alkyl groups having from 1 to 10 carbons, alkenyl groups having from 2 to 10 carbons, or phenyl groups; and, from the perspective of easy of synthesis and release characteristics, are preferably methyl groups, vinyl groups, phenyl groups, or perfluoroalkyl groups, and particularly preferably are all methyl groups.

In order to achieve the objects of the present invention, the component (B) is preferably an organopolysiloxane resin consisting of R¹₃SiO_{1/2} units (wherein R¹ are each independently hydroxyl groups, alkoxy groups having from 1 to 6 carbons, or substituted or unsubstituted monovalent hydrocarbon group having from 1 to 10 carbons) and SiO₄12 units. A molar ratio of the R¹₃SiO_{1/2} units to the SiO_{4/2} units is in a range of 0.5 to 2.0. Especially, A molar ratio of the R¹₃SiO_{1/2} units to the SiO_{4/2} units is preferred to be equal to or more than 0.6, and the ratio is preferably in a range of 0.6 to 1.5, more preferably in a range of 0.65 to 1.2, and particularly preferably in a range of 0.70 to 0.90. If the molar ratio is less than the lower limit described above, compatibility with other siloxane components will decline when compounded in a releasable cured layer-forming organopolysiloxane composition. On the other hand, if the molar ratio exceeds the upper limit described above, the result will be particularly insufficient initial heavy releasability.

In order to achieve the objects of the present invention, the content of the vinyl(CH₂═CH—) part of the alkenyl groups in the component (B) must be less than 1.0% by mass and, from the perspective of suppressing changes in the releasing force over time, the content of the vinyl(CH₂═CH—) part of the alkenyl groups is preferably in a range of 0.0 to 0.9% by mass, more preferably in a range of 0.0 to 0.5% by mass, and particularly preferably, the component (B) is substantially or completely free of alkenyl groups (content=0.0% by mass). If the content of the vinyl(CH₂═CH—) part of the alkenyl groups exceeds the upper limit described above, not only will the component (B) be incorporated into the cured layer due to the addition reaction, leading to the initial heavy releasability being inhibited, changes in the releasing force over time will be prominent, and heavy releasability will be further inhibited over time. Note that in cases where the component (B) is an organopolysiloxane resin consisting of R¹₃SiO_{1/2} units and SiO_{4/2} units, from the perspectives of heavy releasability and suppressing changes over time of the releasing force, all of R¹ are alkyl groups having from 1 to 10 carbons and the component (B) is substantially free of alkenyl groups.

Additionally, the component (B) is preferably substantially free of hydroxyl groups or alkoxy groups. This is because a presence of 2.0% by mass or more of hydroxyl groups or alkoxy groups may result in problems such as the adhesive residue being left on adhesive agents.

The curable organopolysiloxane composition of the present invention is characterized in that a mass ratio of the component (A) to the component (B) is in a range of 2/8 to 8/2. Additionally, a sum of the contents of the component (A) and the component (B) is preferably not less than 50% by mass, more preferably is not less than 60% by mass, and particularly preferably is in a range of 65 to 85% by mass.

The mass ratio of the component (A) to the component (B) is in a range of 2/8 to 8/2, preferably in a range of 7/3 to 3/7, more preferably in a range of 6/4 to 4/6, and particularly preferably is 5:5. If the mass ratio of the component (A) and the component (B) is outside the mass ratio described above, releasing force will decline greatly over time and, as a result, the object of the present invention will not be achievable. On the other hand, if the proportion of the component (B) exceeds the upper limit described above, in addition to curability declining, the viscosity of the organopolysiloxane composition will increase excessively and, as a result, even when used in a solvent-type composition, application, production, and other real tasks may be impeded.

Component (C) is an organohydrogenpolysiloxane having two or more silicon-bonded hydrogen atoms (Si—H) in each molecule, and is a crosslinking agent. The component (C) preferably has at least three silicon-bonded hydrogen atoms in each molecule and, while the bonding sites are not particularly limited, a content of the silicon-bonded hydrogen atoms is preferably from 0.1 to 2.0% by mass and more preferably from 0.5 to 1.8% by mass of the entire organopolysiloxane composition. Examples of silicon-bonded organic groups in the component (C) other than hydrogen atoms include methyl groups, ethyl groups, propyl groups, butyl groups, octyl groups, and similar alkyl groups, of which methyl groups are preferable. Moreover, the molecular structure thereof may be straight, branched, or branched cyclic.

Viscosity at 25° C. of the component (C) is from 1 to 1,000 mPa·s and is preferably from 5 to 500 mPa·s. This is because if the viscosity at 25° C. is less than 1 mPa·s, the component (C) will be prone to volatilizing from the organopolysiloxane composition, and also because if the viscosity at 25° C. exceeds 1,000 mPa·s, curing time of the organopolysiloxane composition will increase. Specific examples of the component (C) described above include a dimethylsiloxane methyl hydrogen siloxane copolymer capped at both molecular terminals with trimethylsiloxy groups, a dimethylsiloxane methyl hydrogen siloxane copolymer capped at both molecular terminals with dimethylhydrogensiloxy groups, dimethylpolysiloxane capped at both molecular terminals with dimethylhydrogensiloxy groups, methylhydrogenpolysiloxane capped at both molecular terminals with trimethylsiloxy groups, cyclic methylhydrogenpolysiloxane, and a cyclic methylhydrogensiloxane dimethylsiloxane copolymer. Note that two or more organohydrogenpolysiloxanes can be used in combination as the component (C).

More preferably, the component (C) is one or two or more types of organohydrogenpolysiloxanes represented by general formula (2) below and, in such a case, the cured layer is formed by the addition reaction (hydrosilylation reaction) of the component (C) with the silicon-bonded alkenyl groups contained in the component (A) and the component (B).

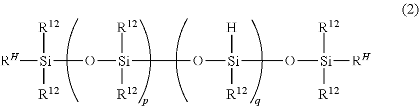

In this formula, R¹² is an unsubstituted or substituted alkyl group or acyl group, and preferably is an alkyl group having from 1 to 10 carbons, a halogenated alkyl group having from 1 to 10 carbons, or a phenyl group. R^{H} is the group represented by R¹² or a hydrogen atom (H), but when q=0, R^{H} is a hydrogen atom (H). “p” is a number not less than 1, “q” is a number not less than 0, and p and q are set such that 10≦(p+q)≦200 is satisfied. If (p+q) is less than the lower limit described above, the component (C) may volatilize which may, depending on the curing conditions, lead to insufficient curing. If (p+q) exceeds the upper limit described above, gel may be produced in the reaction bath over time. Furthermore, regarding p and q, the relationship 0.01≦r/(p+q)≦1, where “r” is the number of silicon-bonded hydrogen atoms (H) in the component (C), is preferably satisfied. This is because if r/(p+q) is less than the lower limit described above, the curing of the curable organopolysiloxane composition according to the present invention may be insufficient. Note that r is the sum of the number of R^{H} silicon-bonded hydrogen atoms (H) and the number of q. For example, when both terminal R^{H} are silicon-bonded hydrogen atoms (H), r=q+2.

The component (C) is compounded at an amount such that a molar ratio of the SiH groups in the component (C) to the vinyl(CH₂═CH—) part of the alkenyl groups in the component (A) and the component (B) is from 0.5 to 5 and preferably from 1 to 3. If this molar ratio is less than the lower limit described above, curability will decline, and if the molar ratio exceeds the upper limit described above, release resistance Will increase excessively, which may result in adhesive residue being left behind or practical release characteristics being impossible to obtain.

Component (D) is a hydrosilylation reaction catalyst that functions to accelerate the addition reaction (hydrosilylation reaction) of the silicon-bonded alkenyl groups and the silicon-bonded hydrogen atoms that are present in the system. Specific examples of preferable hydrosilylation reaction catalysts is platinum based catalyst, and include chloroplatinic acid, alcohol-modified chloroplatinic acid, olefin complex of chloroplatinic acid, ketone complex of chloroplatinic acid, vinylsiloxane complex of chloroplatinic acid, platinum tetrachloride, platinum fine powder, an alumina or silica carrier holding solid platinum, platinum black, platinum-olefin complexes, platinum-alkenylsiloxane complexes, platinum-carbonyl complexes, as well as methyl methacrylate resins, polycarbonate resins, polystyrene resins, silicone resins, and similar thermoplastic organic resin powder platinum-based catalysts in which a platinum catalyst described above is included. A complex of chloroplatinic acid and a divinyltetramethyl disiloxane, a complex of chloroplatinic acid and a tetramethyltetravinylcyclotetrasiloxane, a platinum-divinyltetramethyl disiloxane complex, a platinum-tetramethyltetravinylcyclotetrasiloxane complex, or a similar platinum-alkenylsiloxane complex can be particularly preferably used.

It is sufficient that the component (D) be added in an amount equal to the catalytic quantity which normally is from 1 to 1,000 ppm and the added amount is preferably in a range of 5 to 500 ppm (in terms of platinum metal content contained in the component (D)) with respect to the entire mass of the curable organopolysiloxane composition of the present invention.

The curable organopolysiloxane composition according to the present invention may optionally comprise (E) an organic solvent. Additionally, the curable organopolysiloxane composition according to the present invention may be dispersed in a known organic solvent and then used.

Examples of the component (E) organic solvent include toluene, xylene, and similar aromatic hydrocarbon solvents; hexane, octane, isoparaffin, and similar aliphatic hydrocarbon solvents; acetone, methyl ethyl ketone, methyl isobutyl ketone, and similar ketone-based solvents; ethyl acetate, isobutyl acetate, and similar ester-based solvents; diisopropylether, 1,4-dioxane, and similar ether-based solvents; hexamethyl cyclotrisiloxane, octamethyl cyclotetrasiloxane, decamethyl cyclopentasiloxane, and similar cyclic polysiloxanes having a degree of polymerization of from 3 to 6; trichloroethylene, perchloroethylene, trifluoromethylbenzene, 1,3-bis(trifluoromethyl)benzene, methylpentafluorobenzene, and similar halogenated hydrocarbons. Specifically, the use of toluene or xylene is preferable.

In addition to the components described above, the curable organopolysiloxane composition of the present invention preferably includes: (F) a hydrosilylation reaction suppressing agent in order to suppress gelling and curing at room temperature, enhance storage stability, and impart heat curability characteristics to the composition. Examples of the hydrosilylation reaction suppressing agent include acetylene-based compounds, ene-yne compounds, organic nitrogen compounds, organic phosphorus compounds, and oxime compounds. Specific examples include 2-methyl-3-butyn-2-ol, 3,5-dimethyl-1-hexyn-3-ol, 3-methyl-1-penten-3-ol, 2-phenyl-3-butyn-2-ol, 1-ethynyl-1-cyclohexanol (ETCH), and similar alkyne alcohols; 3-methyl-3-trimethylsiloxy-1-butyne, 3-methyl-3-trimethylsiloxy-1-pentyne, 3,5-dimethyl-3-trimethylsiloxy-1-hexyne, 3-methyl-3-penten-1-yne, 3,5-dimethyl-3-hexen-1-yne, and similar ene-yne compounds; 1-ethynyl-1-trimethylsiloxycyclohexane, bis(2,2-dimethyl-3-butynoxy)dimethylsilane, 1,3,5,7-tetramethyl-1,3,5,7-tetravinylcyclotetrasiloxane, 1,3,5,7-tetramethyl-1,3,5,7-tetrahexenylcyclotetrasiloxane, and similar alkenylsiloxanes. An added amount of hydrosilylation reaction suppressing agent (F) is generally in a range of 0.001 to 5 parts by mass per 100 parts by mass of the component (A), but the added amount may be selected appropriately depending on the type of component used, properties and content of the hydrosilylation reaction catalyst, the content of higher alkenyl groups in the component (A), the number of silicon-bonded hydrogen atoms in the component (C), desired usable life, and the working environment.

The composition of the present invention contains the component (A), the component (B), the component (C), and the component (D), and, optionally, the component (E) and the component (F), and is particularly suitable for use as a solvent-free curable organopolysiloxane composition. Additionally, in order to increase the viscosity of the coating liquid, silica fine powder or a similar thickening agent may also be compounded. From the perspective of ensuring coatability on the sheet-like substrate of the composition of the present invention, the viscosity at 25° C. of the entire composition is preferably in a range of 100 to 100,000 mPa·s, and more preferably is from 500 to 50,000 mPa·s.

The composition of the present invention can be used as a solvent-type curable organopolysiloxane composition necessarily comprising the component (E) and, in such a case, the viscosity at 25° C. of the entire composition is preferably in a range of 100 to 100,000 mPa·s and more preferably is from 100 to 50,000 mPa·s.

Optional components other than the components described above can be added to the curable organopolysiloxane composition according to the present invention. Examples of known additives that can be used include 3-glycidoxypropyltrimethoxysilane, 3-methacryloxypropyltrimethoxysilane, and similar adhesion promoters formed from alkoxysilane compounds; phenol, quinone, amine, phosphorous, phosphite, sulfur, thioether, and similar antioxidants; triazole, benzophenone, and similar photostabilizers; phosphate ester, halogen, phosphorous, antimony, and similar flame retardants; one or more types of surfactants comprising a cationic surfactant, an anionic surfactant, a nonionic surfactant, or the like; anti-static agents; heat resistant agents; dyes; pigments; and the like.

Particularly, it is preferable that an anti-static agent be added to the sheet-like article having the cured layer formed from the composition according to the present invention in cases where used as a surface protective film for protecting the surface of a liquid crystal panel, a plasma display, a polarizing plate, a retardation plate, or similar optical part, a printed circuit board, an IC, a transistor, a capacitor, or other electronic/electric part.

The curable organopolysiloxane composition according to the present invention comprises the components (A) through (D) described above and optionally comprises the component (E) and the component (F). Moreover, the curable organopolysiloxane composition according to the present invention forms a cured layer having superior release characteristics as the result of an addition reaction carried out at room temperature or at from 50 to 200° C., as described hereinafter. However; from the standpoint of ensuring the physical properties and releasability of the obtained cured layer, the composition of the present invention is preferably further cured using ultraviolet light irradiation.

Therefore, in order to impart UV curability to the curable organopolysiloxane composition according to the present invention, (G) a photoinitiator is preferably compounded. Next, a description of the component (G) will be given.

The photoinitiator (G) is a component that functions to impart UV curability to the curable organopolysiloxane composition of the present invention. By combining the addition reaction curing and the UV curing, a benefit of further enhancing the silicone migration characteristics of the composition of the present invention can be obtained. The component (G) is a conventionally known compound in which radicals are generated when exposed to ultraviolet light, and may be appropriately selected from among organic peroxides, carbonyl compounds, organic sulfur compounds, azo compounds, and the like. Specific examples include acetophenone, propiophenone, benzophenone, xanthol, fluorene, benzaldehyde, anthraquinone, triphenylamine, 4-methylacetophenone, 3-pentylacetophenone, 4-methoxyacetophenone, 3-bromoacetophenone, 4-allylacetophenone, p-diacetylbenzene, 3-methoxybenzophenone, 4-methylbenzophenone, 4-chlorobenzophenone, 4,4-dimethoxybenzophenone, 4-chloro-4-benzylbenzophenone, 3-chloroxanthone, 3,9-dichloroxanthone, 3-chloro-8-nonylxanthone, benzoin, benzoinmethylether, benzoinbutylether, bis(4-dimethylaminophenyl)ketone, benzylmethoxyketal, 2-chlorothioxanthone, diethylacetophenone, 1-hydroxycyclohexylphenylketone, 2-methyl[4-(methylthio)phenyl]2-morpholino-1-propanone, 2,2-dimethoxy-2-phenylacetophenone, diethoxyacetophenone, and the like. In cases where the composition of the present invention is UV cured, the component (G) is preferably benzophenone, 4-methoxyacetophenone, 4-methylbenzophenone, diethoxyacetophenone, or 1-hydroxycyclohexylphenylketone, and more preferably is diethoxyacetophenone or 1-hydroxycyclohexylphenylketone.

A single type of the photoinitiator (G) may be used or a combination of two or more types may be used. A compounded amount thereof is not particularly limited, but is in a range of 0.01 to 10 parts by mass, preferably in a range of 0.01 to 2.5 parts by mass, and more preferably in a range of 0.05 to 2.5 parts by mass per 100 parts by mass of the component (A). If the compounded amount of the component (G) is within the range described above, the silicone migration characteristics of the releasable layer formed by curing the composition of the present invention will improve and the releasable layer will have superior strength and other physical properties.

The composition of the present invention can be simply produced by uniformly mixing the components (A) to (D), and the component (F) and the other optional components. The order in which the components are added is not particularly limited but, in cases where the composition is not used immediately after mixing, preferably the components (A), (B), and (C) are mixed and stored separately from the component (D). Furthermore, the mixture of components (A), (B), and (C) is preferably mixed with the component (D) prior to use. Moreover, in a composition including the components (A) to (D) and also the component (F), preferably the compounded amount of the component (F) is adjusted so that crosslinking does not occur at room temperature and, instead, the composition crosslinks and cures when heated.

When the curable organopolysiloxane composition of the present invention described above is applied uniformly to a sheet-like substrate and heated under conditions sufficient so that the component (A) and the component (C) hydrosilylation react and crosslink, heavy releasability with respect to adhesive materials is imparted to the sheet-like substrate surface, and the releasing force thereof changes little over time. As a result, a sheet-like article having a cured layer with superior slipperiness, transparency, and bonding to sheet-like substrates can be produced. Additionally, the cured layer formed by curing the composition of the present invention has superior conformability and breathability and, thus, has a benefit in that air bubbles are not trapped when the composition is applied to uneven surfaces. Therefore, the composition of the present invention can be used particularly preferably in applications where both the release characteristics of the cured layer and the bonding characteristics of the cured layer to the object to be protected are important, such as in protective films for optical displays or glass surfaces.

The sheet-like substrate is substantially flat and, depending on the application, tape, film, and similar substrates having adequate width and thickness can be used without limitation. Specific examples thereof include paper, synthetic resin film, fabric, synthetic fiber, metal foil (aluminum foil, copper foil, and the like), glass fiber, and also compound sheet-like substrates formed by laminating a plurality of said sheet-like substrates.

Examples of synthetic resin films include polyester, polytetrafluoroethylene, polyimide, polyphenylene sulfide, polyamide, polycarbonate, polystyrene, polypropylene, polyethylene, polyvinyl chloride, polyethylene terephthalate, and similar synthetic resin films. The cured layer of the present invention is substantially transparent. Therefore, a protective film with superior transparency can be obtained by selecting a sheet-like substrate having high transparency formed from the synthetic resin films recited above.

Examples of paper include Japanese paper, synthetic paper, polyolefin laminated paper (particularly polyethylene laminated paper), cardboard, and clay coated paper.

As described above, the thickness of the exemplified sheet-like substrate is not particularly limited, but is generally about 5 to 300 μm. Furthermore, in order to improve bonding between the cured layer and the sheet-like substrate, a support film that has been subjected to primer treatment, corona treatment, etching treatment, or plasma treatment may be used. Examples of usable primer compositions include condensation type silicone primers compositions including a condensation reaction catalyst and polydiorganosiloxanes having terminal SiOH groups, polysiloxanes having the SiH group, and/or polysiloxanes having an alkoxy group; and addition type silicone primer compositions including polydiorganopolysiloxanes having an alkenyl group (e.g. vinyl group or the like), polysiloxanes having the SiH group, and an addition reaction catalyst.

The side of the sheet-like substrate that is opposite the cured layer may be surface treated and subjected to scratch resistance, dirt/oil resistance, fingerprint resistance, antiglare, antireflection, antistatic, or a similar treatment. These surface treatments may be carried out after the curable organopolysiloxane composition of the present invention is applied to the sheet-like substrate or the composition may be applied after carrying out the surface treatments.

Examples of scratch resistance treatments (hardcoating treatments) include treatments using acrylate, silicone, oxetane, inorganic, organic/inorganic hybrid, and similar hardcoat agents.

Examples of dirt/oil resistance treatments include treatments using fluorine, silicone, ceramic, photocatalyst, and similar dirt/oil treatment agents.

Examples of antireflection treatments include wet treatments in which a fluorine, silicone, or similar antireflection agent is applied, and dry treatments carried out via vapor deposition or sputtering of said agents. Examples of the antistatic treatments include treatments using surfactant, silicone, organic boron, conductive polymer, metal oxide, vapor deposited metal, and similar anti-static agents.

Generally, an appropriate temperature for curing the curable organopolysiloxane composition of the present invention on the sheet-like substrate is from 50 to 200° C. but, provided that the heat resistance of the sheet-like substrate is excellent, the temperature may be 200° C. or higher. The method of heating is not particularly limited, and examples thereof include heating in a hot-air circulation oven, passing through a long heating furnace, and heat ray radiation by an infrared lamp or halogen lamp. The curable organopolysiloxane composition may also be cured using a combination of heating and UV light irradiation. When the component (D) is a platinum-alkenylsiloxane complex catalyst, even in cases where the compounded amount thereof is (in terms of platinum metal content) from 80 to 200 ppm per the total mass of the composition, a cured layer with superior slipperiness, transparency, and bonding to the sheet-like substrate can be easily obtained at a curing temperature of 100 to 150° C. in a short time of from 1 to 40 seconds.

On the other hand, in cases where a polyolefin or similar sheet-like substrate that has low heat resistance is used, the curable organopolysiloxane composition of the present invention is preferably heated at a low temperature of from 50° C. to 100° C. and more preferably of from 50° C. to 80° C. after being applied on the polyolefin or similar sheet-like substrate. In this case, curing can be stably performed using a curing time of from 30 seconds to several minutes (e.g. 1 to 10 minutes).

Examples of the method for applying the curable organopolysiloxane composition of the present invention to the sheet-like substrate surface include dipping, spraying, gravure coating, offset coating, offset gravure coating, roll coating using an offset transfer roll coater or the like, reverse roll coating, air knife coating, curtain coating using a curtain flow coater or the like, comma coating, and Meyer bar coating. These and other known methods used for forming a cured layer can be used without limitation.

Coating weights are selected based on the use, but coating weights from 0.01 to 200.0 g/m² on the sheet-like substrate are common. A coating weight from 0.01 to 100.0 g/m² can be selected in cases where the intent is to thinly apply the curable organopolysiloxane of the present invention as a release layer. Furthermore, a coating weight from 0.1 to 50.0 g/m² can be selected in cases where the intent is to thickly apply the curable organopolysiloxane of the present invention for uses where releasability and bonding are both required, such as in a protective film use. Slipperiness, heavy releasability, and other characteristics are superior in cases where the curable organopolysiloxane of the present invention is particularly thickly applied and, furthermore, declines in releasing force over time are suppressed. Therefore, coating weights from 0.01 to 100.0 g/m² are available and preferable.

The cured layer formed from the curable organopolysiloxane composition of the present invention imparts heavy releasability to adhesive materials and functions as a releasable cured layer in which releasing force changes little over time. On the other hand, by applying a thick cured layer, the cured layer can also be used as slightly-adhesive bonding layer with superior re-adhering characteristics.

The composition of the present invention is useful for forming a cured layer that has superior surface slipperiness and releasability with respect to adhesive materials, and particularly can be preferably used as a releasable cured layer-forming agent for casting paper, asphalt packaging paper, and various types of plastic films.

Particularly, the cured layer formed from the composition of the present invention has superior heavy releasability with respect to other adhesive layers and this releasing force does not decrease greatly over time and, thus, can be used as a release layer for a laminate such as a laminate comprising an adhesive layer such as casting paper, adhesive material packaging paper, adhesive tape, adhesive labels, and the like. Specifically, by using the curable organopolysiloxane composition of the present invention, a laminate can be obtained that is formed by adhering (SA) an adhesive sheet having an adhesive agent layer (or adhesive layer) on at least one side of a sheet-like substrate to (S1) a sheet-like substrate having a cured layer (release layer or releasable layer), formed by heat curing the curable organopolysiloxane composition of the present invention on at least one side thereof, so that the adhesive agent layer contacts the cured layer.

Examples of the adhesive material applied to the laminate described above include various types of adhesives, various types of bonding agents, acrylic resin-based adhesives, rubber-based adhesives, and silicone-based adhesives; acrylic resin-based bonding agents, synthetic rubber-based bonding agents, silicone-based bonding agents, epoxy resin-based bonding agents, and polyurethane-based bonding agents. Other examples include asphalt, soft rice-cake-like sticky foods, glue, and birdlime.

A protection sheet or releasable bonding sheet provided with the cured layer formed from the composition of the present invention can be used in applications in which the protection sheet or releasable bonding sheet is adhered to the surface of an article to protect the article when transporting, processing, or curing. Examples of the article include metal plates, coated metal plates, aluminum window sashes, resin plates, decorative steel plates, vinyl chloride-steel plate laminates, glass plates, and the like. Additionally, the protection sheet or releasable bonding sheet can be advantageously used as a protection sheet for use in the manufacturing process of various types of liquid crystal display panels (also called monitors or displays), the distribution process of polarizing plates, the manufacturing process and distribution process of various types of mechanical resin members for use in vehicles and the like, food packaging, and the like.

Likewise, the protection sheet provided with the bonding layer formed from the cured layer of the present invention can be easily re-adhered and, as a result, can be used as a protection sheet for the following types of displays. The protection sheet of the present invention is used for the purposes of surface scratch resistance, dirt/oil resistance, fingerprint resistance, antistatic, antireflection, privacy, and the like in all situations including during the manufacturing, distribution, and use of these displays.

Specifically, by using the curable organopolysiloxane composition of the present invention, a laminate (surface protection sheet) can be obtained that is formed by adhering (SR) a release sheet having a release layer on at least one side of a sheet-like substrate to (S1) a sheet-like substrate having a cured layer (release layer or bonding layer), formed by heat curing the curable organopolysiloxane composition of the present invention on at least one side thereof, so that the release layer contacts the cured layer.

### EXAMPLES

Hereinafter, the present invention is described in detail with reference to Practical Examples and Comparative Examples, but it should be understood that the present invention is not limited to these Practical Examples. Note that in the following examples, all references to “parts” mean “parts by mass,” “Hex” means “hexenyl group,” and “Me” means “methyl group.” Viscosity and plasticity values were measured at 25° C. Furthermore, in the following examples, “M” is a monofunctional siloxane unit represented by (CH₃)₃SiO_{1/2}, “M^{Vi}” is a monofunctional siloxane unit represented by (CH₃)₂(CH₂═CH)SiO_{1/2}, and “Q” is a tetrafunctional siloxane unit represented by SiO₂. Additionally, change over time of the release resistance value of the cured layer formed from the curable organopolysiloxane composition was measured according to the method described below.

Formation of the Cured Layer

The curable organopolysiloxane composition was applied to a surface of polyethylene laminated paper at a coating weight of 0.8 g/m² (based on siloxane weight) using an RI-2 Printability Tester (manufactured by Akira Seisakusho Co., Ltd.). Then, the coated substrate was heat treated in a circulating hot air oven for 30 seconds at 130° C. Thus, a cured layer was formed on the surface of the substrate.

Release Resistance Value

An acrylic solvent-type adhesive (Oribain BPS-5127, manufactured by Toyo Ink Mfg. Co., Ltd.) was uniformly applied to the cured layers described in the Practical and Comparative Examples using an applicator at an amount such that the solid content thereof was 30 g/M², and heated for two minutes at a temperature of 70° C. Then, high-grade paper having a basis weight of 64 g/m² was adhered to the acrylic adhesive surface, and a test piece having a width of 5 cm was cut from the adhered paper. A load of 20 g/cm² was applied to the test piece and left to rest in open air for 24 hours at a temperature of 25° C. and a humidity of 60%. Thereafter, the adhered paper was pulled at an angle of 180° and a peel rate of 0.3 m/min using an adhesion release tester (TENSILON universal material testing instrument, manufactured by A&D Co., Ltd.). The force required to peel (mN/50 mm) was measured and regarded as initial releasing force. Furthermore, the same test piece was left to rest in open air for five days at a temperature of 70° C. and a humidity of 60% and then was pulled under the same conditions. The force required to peel (mN/50 mm) was measured and regarded as successive releasing force.

### Practical Example 1

### Composition 1

(A1) 50.0 parts of a polydimethyl siloxane having hexenyl groups at both molecular terminals and on the side chain (viscosity: 100 mPa·s, content of vinyl(CH₂═CH—) part of hexenyl group: 3.00% by mass);

(B1) 50.0 parts of a methylpolysiloxane resin represented by M_{0.74}Q₁ (vinyl group content: 0.0% by mass); (C1) 11.0 parts of a methylhydrogenpolysiloxane capped at both molecular terminals with trimethylsiloxy groups having a viscosity of 25 mPa·s (silicon-bonded hydrogen atom content: 1.6% by mass); and (F) 0.3 parts of 1-ethynyl-1-cyclohexanol (ETCH) were uniformly mixed. Thus, a solvent-free curable organopolysiloxane composition (composition 1) having a viscosity of 800 mPa·s was obtained. Furthermore, (D) chloroplatinic acid-1,3-divinyl-1,1,3,3-tetramethyldisiloxane complex (platinum metal content: 0.6% by mass) was added to the obtained organopolysiloxane composition at an amount such that a content of the platinum metal was 100 ppm. This mixture was applied to the polyethylene laminated paper according to the method described above at an amount resulting in a coating weight of 0.8 g/m² and cured. The release resistance of the cured layer thus formed was measured and the results are shown in Table 1.

### Practical Example 2

### Composition 2

Other than using (B2) a methylvinylpolysiloxane resin represented by (MM^{Vi})_{0.74}Q₁ (vinyl group content: 0.9% by mass), in place of the component (B1) of Practical Example 1, Practical Example 2 was prepared in the same manner as Practical Example 1. The release resistance of the cured layer thus formed was measured and the results are shown in Table 1.

### Comparative Example 1

### Comparative Composition 1

Other than using a polydimethyl siloxane having hexenyl groups at both molecular terminals and on the side chain (viscosity: 220 mPa·s, content of vinyl(CH₂═CH—) part of hexenyl group: 1.15% by mass) in place of the component (A1) of Practical Example 1, Comparative Example 1 was prepared in the same manner as Practical Example 1. The release resistance of the cured layer thus formed was measured and the results are shown in Table 1.

### Comparative Example 2

### Comparative Composition 2

Other than using a polydimethyl siloxane having vinyl groups at both molecular terminals and on the side chain (viscosity: 100 mPa·s, vinyl group content: 3.00% by mass) in place of the component (A1) of Practical Example 1, Comparative Example 2 was prepared in the same manner as Practical Example 1. The release resistance value of the cured layer thus formed was measured and the results are shown in Table 1.

### Comparative Example 3

### Comparative Composition 3

Other than using a methylvinylpolysiloxane resin represented by (MM^{Vi})_{0.74}Q₁ (vinyl group content: 1.9% by mass), in place of the component (B1) of Practical Example 1, Comparative Example 3 was prepared in the same manner as Practical Example 1. The release resistance value of the cured layer thus formed was measured and the results are shown in Table 1.

### Comparative Example 4

### Comparative Composition 4

Other than using a polydimethyl siloxane having vinyl groups at both molecular terminals (viscosity: 60 mPa·s, vinyl group content: 1.60% by mass) in place of the component (A1) of Practical Example 1, Comparative Example 4 was prepared in the same manner as Practical Example 1. The release resistance value of the cured layer thus formed was measured and the results are shown in Table 1.

### Comparative Example 5

### Comparative Composition 5

Other than using a polydimethyl siloxane having vinyl groups at both molecular terminals (viscosity: 60 mPa·s, vinyl group content: 1.60% by mass) in place of the component (A1) of Practical Example 1, and a methylvinylpolysiloxane resin represented by (MM^{Vi})_{0.74}Q₁ (vinyl group content: 1.9% by mass) in place of the component (B1) of Practical Example 1, Comparative Example 5 was prepared in the same manner as Practical Example 1. The release resistance value of the cured layer thus formed was measured and the results are shown in Table 1.

TABLE 1

| | Pulling rate at measurement of release | | |
|---|---|---|---|
| | resistance value (0.3 m/min) | | |
| | Initial | Successive | Release |
| | release | release | resistance |
| | resistance | resistance | value |
| | value | value | difference |
| Release resistance value | (25° C.- | (70° C.- | (change over |
| (mN/50 mm) | 1 day) | 5 days) | time) |
| Practical Example 1 | 8000 | 7800 | −200 |
| (Composition 1) | | | |
| Practical Example 2 | 5700 | 5000 | −700 |
| (Composition 2) | | | |
| Comparative Example 1 | 4900 | 3700 | −1200 |
| (Comparative Composition 1) | | | |
| Comparative Example 2 | 7200 | 4300 | −2900 |
| (Comparative Composition 2) | | | |
| Comparative Example 3 | 5100 | 2750 | −2350 |
| (Comparative Composition 3) | | | |
| Comparative Example 4 | 6300 | 3700 | −2600 |
| (Comparative Composition 4) | | | |
| Comparative Example 5 | 5000 | 2450 | −2550 |
| (Comparative Composition 5) | | | |

As shown in Table 1, when the type of the component (A) (i.e. Comparative Examples 1, 2, and 4), the type of the component (B) (i.e. Comparative Example 3), or the types of both the component (A) and the component (B) (i.e. Comparative Example 5) varies from that stipulated in the claims of the present application, either the initial heavy releasability is insufficient or the release resistance value decreases greatly over time. In contrast, in Practical Example 1 and Practical Example 2 of the present application, excellent initial heavy releasability is displayed and decreases in the release resistance value are suppressed greatly, even under identical aging conditions. Particularly, in Practical Example 1 that was free of alkenyl groups and where the component (B1) formed from MQ units was used, both initial heavy releasability and stability over time were best.

1. A curable organopolysiloxane composition comprising:
(A) at least one type of gum-like or liquid organopolysiloxane having a viscosity at 25° C. of not less than 20 mPa·s, a content of the vinyl(CH₂═CH—) part of higher alkenyl groups having from 4 to 12 carbons being in a range of 2.0 to 5.0% by mass;
(B) an organopolysiloxane resin essentially comprising R¹₃SiO_{1/2} units and SiO_{4/2} units wherein R¹ are each individually hydroxyl groups, alkoxy groups having from 1 to 6 carbons, or substituted or unsubstituted monovalent hydrocarbon groups having from 1 to 10 carbons, a molar ratio of the R¹₃SiO_{1/2} units to the SiO_{4/2} units being from 0.5 to 2.0 and a content of the vinyl(CH₂═CH—) part of the alkenyl groups being less than 1.0% by mass;
(C) an organohydrogenpolysiloxane having two or more silicon-bonded hydrogen atoms (Si—H) in each molecule; and
(D) a hydrosilylation reaction catalyst;
a mass ratio of component (A) to component (B) being in a range of 2/8 to 8/2.

2. The curable organopolysiloxane composition according to claim 1, wherein:
component (B) is an organopolysiloxane resin consisting of R²₃SiO_{1/2} units and SiO_{4/2} units, wherein R² are each individually alkyl groups having from 1 to 10 carbons or alkenyl groups having from 2 to 10 carbons;
the molar ratio of the R²₃SiO_{1/2} units to the SiO_{4/2} units is from 0.5 to 1.0; and
the content of the vinyl(CH₂═CH—) part of the alkenyl groups is less than 1.0% by mass.

3. The curable organopolysiloxane composition according to claim 1, wherein:
component (B) is an alkenyl group-free organopolysiloxane resin consisting of R³₃SiO_{1/2} units and SiO_{4/2} units, wherein R³ are each individually alkyl groups having from 1 to 10 carbons; and
the molar ratio of the R³₃SiO_{1/2} units to the SiO_{4/2} units is from 0.5 to 1.0.

4. The curable organopolysiloxane composition according to claim 1, wherein a content of the vinyl(CH₂═CH—) part of hexenyl groups in component (A) is in a range of 2.5 to 3.5% by mass.

5. The curable organopolysiloxane composition according to claim 1, wherein the mass ratio of component (A) to component (B) is in a range of 6/4 to 4/6.

6. A sheet-like article having a cured layer formed by heat curing the curable organopolysiloxane composition described in claim 1.

7. The sheet-like article according to claim 6, wherein the cured layer is formed by applying the curable organopolysiloxane composition to a sheet-like substrate at an amount of 0.01 to 100.0 g/m², and then heat curing.

8. The sheet-like article according to claim 7, wherein the sheet-like substrate is a polyethylene laminated paper or a plastic film.

9. A surface protection sheet comprising the sheet-like article described in claim 6.

10. A laminate formed by adhering:
(SA) an adhesive sheet having an adhesive agent layer on at least one side of a sheet-like substrate to
(S1) a sheet-like substrate having a cured layer, formed by heat curing the curable organopolysiloxane composition described in claim 1 on at least one side thereof,
so that the adhesive agent layer contacts the cured layer.

11. A laminate formed by adhering:
(SR) a release sheet having a release layer on at least one side of a sheet-like substrate to
(S1) a sheet-like substrate having a cured layer, formed by heat curing the curable organopolysiloxane composition described in claim 1 on at least one side thereof,
so that the release layer contacts the cured layer.

12. The curable organopolysiloxane composition according to claim 2, wherein a content of the vinyl(CH₂═CH—) part of hexenyl groups in component (A) is in a range of 2.5 to 3.5% by mass.

13. The curable organopolysiloxane composition according to claim 3, wherein a content of the vinyl(CH₂═CH—) part of hexenyl groups in component (A) is in a range of 2.5 to 3.5% by mass.

14. The curable organopolysiloxane composition according to claim 1, wherein component (A) comprises an organopolysiloxane represented by the following structural formula (1): 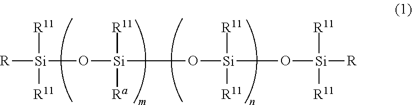
where R¹¹ are each independently unsubstituted or halogen atom substituted alkyl groups having from 1 to 20 carbons, aryl groups having from 6 to 22 carbons, lower alkenyl groups having from 2 to 3 carbons, or hydroxyl groups; R^{a} is a higher alkenyl group having from 4 to 12 carbons; R is the group represented by R¹¹ or R^{a}; “m” is a number greater than or equal to 0; and “n” is a number greater than or equal to 1.

15. The curable organopolysiloxane composition according to claim 14, wherein component (A) comprises an organopolysiloxane represented by the following structural formula: 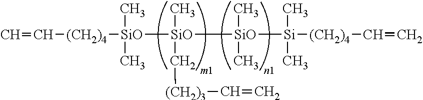
where “m1” is a number such that the content of the vinyl(CH₂═CH—) part of hexenyl groups (—(CH₂)₄CH═CH₂) in each molecule is in a range of 2.0 to 5.0% by mass, alternatively 2.5 to 4.0% by mass; “n1” is a number greater than or equal to 1; and m1+n1 is a number such that the viscosity of component (A) at 25° C. is in a range of 20 to 1,000 mPa·s.

16. The curable organopolysiloxane composition according to claim 1, wherein component (C) comprises an organohydrogenpolysiloxane represented by the following general formula (2): 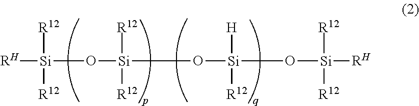
where R¹² is an unsubstituted or substituted alkyl group or aryl group, a halogenated alkyl group having from 1 to 10 carbons, or a phenyl group; R^{H} is the group represented by R¹² or a hydrogen atom; “p” is a number not less than 1; “q” is a number not less than 0, but if “q”=0, then R^{H} is a silicon-bonded hydrogen atom; and 10≦(p+q)≦200.
